(19) United States
(12) Patent Application Publication
(10) Pub. No.: US 2024/0245496 A1
(43) Pub. Date: Jul. 25, 2024

(54) Method and Device for Producing a Dental Prosthesis

(71) Applicant: Kulzer GmbH, Hanau (DE)

(72) Inventors: Matthias Moeller, Eriskirch (DE); Frank-Uwe Stange, Langenargen (DE); Oliver Schmidt, Breuberg (DE); Vesna Bilic-Page, Wuppertal (DE); Stephan Berger, Meckenbeuren (DE)

(21) Appl. No.: 18/289,908

(22) PCT Filed: Apr. 4, 2022
(86) PCT No.: PCT/EP2022/058874

§ 371 Date: Nov. 8, 2023

(30) Foreign Application Priority Data
May 10, 2021 (DE) 10 2021 112 178.7

(51) Int. Cl. A61C 13/00; A61C 13/08

(52) U.S. Cl. CPC A61C 13/0004; A61C 13/0019; A61C 13/081

(57) ABSTRACT

This invention relates to a method for producing dental prostheses, having the steps of:
A) producing a prosthetic base with at least one receptacle and one protruding pin or providing such a prosthetic base;
B) producing or basally machining at least one dental molding with a basal cavity for receiving the pin and a lateral opening in the circumferential surface, such that the basal cavity is accessible via the lateral opening;
C) subsequently applying an adhesive into the basal cavity and/or into the at least one receptacle;
D) subsequently inserting the at least one dental molding into the at least one receptacle of the prosthetic base, such that the protruding pin is arranged inside the basal cavity;
E) subsequently pushing the at least one dental molding into the at least one receptacle, and excess adhesive exiting through the lateral opening in the circumferential surface, wherein the lateral opening protrudes at least in places in the coronal direction beyond an adjoining gingival margin of the prosthetic base; and
F) subsequently curing the adhesive.

The disclosure also relates to a device for producing dental prostheses using such a method, to a dental molding and to a dental prosthesis produced using such a method.

The invention relates to a method and a device for producing dental prostheses as well as to a dental molding, which is suitable for implementation of the method and is producible with the device, and to a dental prosthesis produced using such a method. Dental prostheses are produced with basally machined dental moldings, wherein the dental prostheses are fabricated in the form of partial or full dental prostheses.

In addition to craft skills, digital manufacturing methods are becoming increasingly significant in the dental sector. Dental prostheses and other dental molded parts, such as for example crowns, bridges and three-dimensional models of a patient's oral cavity, have for some years been produced by means of computer-aided design/computer-aided manufacturing (CAD/CAM) technologies using subtractive milling methods. CAD/CAM methods are increasingly also used in the production and design of partial and full dental prostheses with a prosthetic base for placing on the gingiva and dental moldings attached or arranged therein.

Furthermore, generative CAM methods such as stereolithography and digital light processing (DLP) have been becoming increasingly significant for polymer-based dental products, such as for example for temporary dental appliances, prostheses, maxillary orthopedic appliances, occlusal splints, drilling jigs or dental models.

For the purposes of digital design of prosthetic work, in particular of partial or total prostheses, the structure can be divided into a “white” tooth portion (the prosthetic teeth or dental moldings) and a gum-colored prosthetic base portion (the prosthetic base).

There are methods, such as for example the methods known from DE 10 2009 056 752 A1 or WO 2013/124 452 A1, in which a partial or total dental prosthesis is waxed up digitally and produced by means of CAD/CAM methods. Patent DE 103 04 757 B4 discloses a method for producing dental prostheses in which the teeth are virtually waxed-up in a virtual model and a prosthetic base is produced on the basis of the virtual model. EP 2 742 906 A1 discloses a method in which a dental arch is connected to an impression composition, wherein the impression composition is held in an individualized impression tray and contains an impression of the situation in the patient's oral cavity. The surface of the mold with the dental arch is digitized and then a virtual model of the dental arch is computationally positioned and oriented with the best possible fit in the virtual model of the prosthetic base.

For the purposes of digital total prosthetics or partial prosthetics, prosthetic teeth or dental moldings are required which can be clearly and reproducibly adhesively bonded to the prosthetic base.

DE 10 2005 014 319 A1 discloses prosthetic teeth with a cavity and with mesial and distal recesses. The cavity and recesses here serve to reduce the effort involved in basal shortening of factory-made, prefabricated prosthetic teeth and so reduce the effort involved for the dental technician in machining the prosthetic teeth. The intention is to reduce grinding and milling of the dental prostheses. This does not lead to an improvement in positioning precision. A method for producing a dental prosthesis is known from DE 10 2007 002 178 A1 in which prosthetic teeth are adhesively bonded into a prosthetic base. In this case, the prosthetic teeth are produced using a rapid prototyping method. DE 10 2015 107 006 A1 discloses a method for positioning prosthetic teeth in a prosthetic base with the assistance of pins and engaging means.

WO 2016/091 762 A1 discloses a method for producing a dental prosthesis, in which a jig is produced with which a plurality of prosthetic teeth may be fastened in the desired location and orientation relative to one another on a prosthetic base. In this case, the prosthetic teeth are shortened by basal grinding in a cervical region, to achieve the desired occlusal height. WO 2016/110 392 A1 discloses a method for producing a dental prosthesis, in which a plastically deformable connecting means is introduced into dental alveoli of a prosthetic base in order to enable manual correction of the orientation of the prosthetic teeth in the prosthetic base. DE 10 2008 019 694 B3 discloses a method and apparatus for producing dental bodies from ceramics with a laser. EP 2 571 451 B1 and EP 2 666 438 A2 disclose methods for producing dental prostheses in which prefabricated prosthetic teeth are embedded in a wax mount and then milled away cervically by means of CAM methods. The prosthetic teeth shortened in this manner are removed from the wax and then inserted in a prosthetic base and adhesively bonded therein in order to produce a dental prosthesis. It is necessary to shorten the prosthetic teeth basally in order to adapt tooth height to the patient's jaw, i.e. to tailor the occlusal height of the dental prosthesis to the patient's requirements.

The following options are therefore available for producing digitally designed partial or total prostheses:

1) Post-milling of dental moldings embedded in wax in order to achieve the required shortening. However, this does not provide any consistent protection against rotation, nor a uniform adhesive gap, such that adhesive bonding may have toa proceed with an auxiliary matrix.

2) Bringing about a basal fit with rotation protection by way of the external geometry of the dental molding using a very small adhesive gap. The dental moldings can then no longer be shortened for geometric reasons. If the outer contours of the prosthetic base relative to the dental moldings differ slightly from one another, no rotation protection, and no definite end position, is any longer provided.

3) The prosthetic work may optionally also be fabricated completely without joining technology from a red-and-white laminated one-piece blank. This, however, comes with considerable limitations in terms of esthetics, manufacture and costs.

In many processes based on digital modes of working, it is not possible to work with indexes or lock-nut systems, such that positioning has to proceed purely by keying between the molding and the base.

The required precision, in the range of more accurate than 80 μm, preferably more accurate than 50 μm, cannot be mapped with conventional artificial dental moldings, since their geometry is not suitable for precise keying.

A further currently unsatisfactorily solved problem is that of complete, maximally clean removal of excess cement. In particular in the case of hollow-shaped geometries such as caps but also in cavities in the base, the cement may lead to enlargement of the predefined adhesive gap and thus to poor fitting of the dental molding in the prosthetic base. Sufficiently precise adaptation is currently achievable only to a very limited degree due to the impossibility of monitoring.

Even if the dental moldings are very precisely fabricated, deviations may arise on insertion and cementing-in of the dental moldings into the prosthetic base, leading to an undesired deviation between the digital virtual model of the dental prosthesis and the physical dental prosthesis. Occlusal height (occlusion) may in particular vary, meaning that the adhesive gap between the basal (cervical) end of the dental molding and the receiving surface in the prosthetic base is not always of equal size. This leads to a need for complex coronal post-machining of the dental moldings after adhesive bonding of the dental moldings with the prosthetic base. Coronal post-machining may in this case also impair the esthetic appearance of the dental prosthesis.

A further disadvantage of previous methods is that the adhesive has to be removed over the entire transitional area between the dental moldings and the prosthetic base so as to prevent adhesive residues along the entire gingival margin between the prosthetic base and the dental molding(s), which are troublesome and esthetically disadvantageous when the prosthesis is worn.

The object of the invention is to overcome the disadvantages of the prior art. In particular, there is a need for a possible way to provide a method and a device and dental moldings with which a precisely fitting attachment of dental moldings in prosthetic bases is possible, wherein inaccuracy in the positioning of the dental moldings relative to the prosthetic base caused by the adhesive can be reduced or prevented. At the same time, the position and orientation of the dental moldings needs to be defined as accurately as possible, in order to prevent mispositioning of the dental moldings in the prosthetic base. Furthermore, basal shortening of the dental moldings ideally needs to enabled, without its being impossible or more difficult to meet the other requirements in terms of positioning the dental moldings in the prosthetic base. The method needs to be as easy and straightforward as possible for the dental technician to implement. In particular, fully automated or maximally automated methods such as CAD/CAM technologies need to be used and usable. Post-machining of the dental prosthesis needs to be maximally straightforward to achieve. Results which can be reproduced as well as possible with a consistently high quality also need to be achievable. Excess adhesive needs to be removable as easily as possible, wherein at the same time a connection needs to be achieved or producible over the entire area between the prosthetic base and the at least one dental molding.

The objects of the invention are achieved by a method according to Claim 1, a device according to Claim 11 and a dental molding according to Claim 13. Preferred variants are claimed in subclaims 2 through 10, 12, 14 and 15.

The objects of the invention are thus achieved by a method for producing dental prostheses in the form of partial or full dental prostheses, wherein the dental prosthesis has a prosthetic base and at least one dental molding and wherein the method is characterized by the following steps:
A) producing a prosthetic base from a gum-colored plastics material, wherein the prosthetic base is created with at least one receptacle for at least one dental molding and wherein a protruding pin is created in the at least one receptacle, or providing a prosthetic base of a gum-colored plastics material, wherein the prosthetic base has at least one receptacle for at least one dental molding and wherein a protruding pin is arranged in the at least one receptacle;
B) producing or basally machining at least one dental molding, wherein a basal cavity for receiving the pin is created in the at least one dental molding or the at least one dental molding has a basal cavity for receiving the pin, wherein a lateral opening is created in the circumferential surface of the at least one dental molding, such that the basal cavity is accessible via the lateral opening in the circumferential surface of the at least one dental molding;
C) subsequently applying an adhesive into the basal cavity of the at least one dental molding or into the at least one receptacle of the prosthetic base or into the basal cavity of the at least one dental molding and into the at least one receptacle of the prosthetic base;
D) subsequently inserting the at least one dental molding into the at least one receptacle of the prosthetic base, such that the protruding pin is arranged inside the basal cavity;
E) subsequently pushing the at least one dental molding into the at least one receptacle, and excess adhesive exiting through the lateral opening in the circumferential surface of the at least one dental molding, wherein the lateral opening in the circumferential surface of the at least one dental molding protrudes at least in places in the coronal direction beyond an adjoining gingival margin of the prosthetic base; and
F) subsequently curing the adhesive to definitively connect the at least one dental molding to the prosthetic base.

Dental prostheses and thus partial and full dental prostheses are provided as replacements for teeth that have been completely lost. They comprise at least one dental molding and a prosthetic base. The prosthetic base imitates the gum. A prosthetic base may be laid on a toothless jaw or be attached thereto. The dental molding or moldings serve(s) to reproduce lost teeth and should in particular also restore the chewing function of the jaw and also the esthetic appearance.

A dental molding has a coronal surface and an opposing basal side. The basal side is arranged opposite the coronal surface. The coronal surface comprises the bite surface (occluding surface) of the dental molding and the surrounding adjoining lateral areas and preferably should not be machined or only as little as possible. The basal side serves to anchor the dental molding in the prosthetic base and may also be denoted the cervical region. The basal side of a dental molding may to this end be inserted in a receptacle in the form of at least one matching tooth socket in the prosthetic base and connected thereto.

The circumferential surface of a dental molding is the surface of the dental molding which is arranged between the coronal surface and the basal side. The term “circumferential surface” is derived from the roughly cylindrical morphology and symmetry of the dental molding or of a prosthetic tooth, wherein the cylinder axis extends from the basal side to the coronal side of the dental molding through the centroid thereof. The circumferential surface of the dental molding thus connects the coronal surface and the basal surface of the dental molding. It could also be said that the circumferential surface comprises all those surfaces of the dental molding which are not the coronal surface and not the basal surface. The circumferential surface encloses the dental molding.

The at least one dental molding may preferably be an industrially premanufactured, prefabricated dental molding. The at least one dental molding may be present in the form of an individual prosthetic tooth or in the form of a plurality of individual prosthetic teeth, as well as in the form of at least one cohesive or one-piece assembly of a plurality of connected-together prosthetic teeth, preferably in the form of at least one cohesive or one-piece assembly of two to four prosthetic teeth.

The gingival margin (also known as the gum margin in the case of natural dentition) is understood by a person skilled in the art (and should here be understood) to mean the boundary line at the surface of the dental prosthesis at which the at least one dental molding adjoins the prosthetic base when inserted. In other words, it is the area of transition from the imitation gum to the at least one dental molding at the surface of the dental prosthesis.

In methods according to the invention it may be provided that in step B), when producing or basally machining the at least one dental molding, and in step A), when producing the prosthetic base, a virtual 3D model of a dental prosthesis is created or provided with a virtual model of the prosthetic base as imitation gum and with at least one virtual model of the at least one dental molding to be arranged in the prosthetic base to reproduce at least one tooth.

In this way, the method may be implemented particularly simply and inexpensively using modern CAD/CAM methods. This gives rise, as a result, to automation and better reproducibility of the method.

In this respect, it may be provided that the lateral opening in the circumferential surface of the at least one dental molding is added computationally in the virtual model or in the virtual models within the scope of the method, wherein preferably the lateral opening is added in such a way in the circumferential surface of the at least one dental molding that the lateral opening in the circumferential surface of the at least one dental molding projects in the coronal direction beyond the gingival margin of the prosthetic base when the at least one dental molding is inserted fully into the receptacle assigned thereto, wherein particularly preferably the lateral opening in the circumferential surface of the at least one dental molding projects in the coronal direction by at least 0.1 mm beyond the gingival margin of the prosthetic base, very particularly preferably the lateral opening in the circumferential surface of the at least one dental molding projects in the coronal direction by at least 0.3 mm beyond the gingival margin of the prosthetic base.

In this way, it may be ensured that the lateral opening in the circumferential surface of the at least one dental molding for exit of the adhesive is arranged automatically and at the desired position and with the desired effect. Production or machining of the at least one dental molding may then proceed fully automatically.

It may further be provided that in step E) the at least one dental molding is pushed into the at least one receptacle up to a limit stop, wherein the limit stop is preferably formed by a coronal end of the pin and by a mating stop at the coronal base in the basal cavity.

In this case it can be provided that the end of the pin is a top surface and the mating stop is a coronal base surface of the basal cavity fitting with the bearing surface.

This measure ensures correct positioning and very precise adjustment of the occlusion (occlusal height) of the at least one dental molding in the prosthetic base. In this way, complex post-machining of the dental prosthesis to adjust the occlusion can be reduced or avoided.

It is furthermore provided that, on pushing the at least one dental molding into the at least one receptacle, in step E) the pin is guided in the basal cavity and the at least one dental molding is thereby oriented and positioned relative to the prosthetic base.

To this end, the pin may be shaped so as to taper conically at least in places in the coronal direction and/or the basal cavity may be shaped so as to taper conically at least in places in the coronal direction.

In this way it is ensured that the at least one dental molding can be easily inserted into the at least one receptacle of the prosthetic base, orienting and centering itself in the process. In this way, insertion of the at least one dental molding into the prosthetic base is thus simplified.

It may be provided that the prosthetic base is produced with multiple receptacles for a dental molding or for multiple dental moldings or the provided prosthetic base has multiple receptacles for a dental molding or for multiple dental moldings, wherein the pins of the receptacles and the basal cavities of the dental moldings have respectively paired, matching indexing, such that each of the dental moldings fits precisely with one receptacle and can be attached in one position and orientation in this receptacle.

This prevents the positions of dental moldings from being mixed up.

It may also be provided that the pin of the at least one receptacle and the basal cavity of the at least one dental molding is produced with rounded structures with a radius of curvature of at least 0.3 mm or has rounded structures with a radius of curvature of at least 0.3 mm, preferably is produced with a radius of curvature of at least 0.5 mm or has a radius of curvature of at least 0.5 mm.

In this way, it is ensured that the dental moldings may be produced and machined using subtractive CAM methods. This in particular enables machining using CAM milling.

According to one preferred further development, it may be provided that a top surface of the pin of the at least one receptacle and a coronal base surface in the basal cavity of the at least one dental molding have a non-rotationally symmetrical profile or are produced with a non-rotationally symmetrical profile, or a top surface of the pin of the at least one receptacle and a coronal base surface in the basal cavity of the at least one dental molding have an omega-shaped profile or are produced with an omega-shaped profile.

For the purposes of the present invention, an omega-shaped profile is understood to mean a planar surface body in which a round, oval, elliptical or circular surface is connected at one side to a rectangular surface, such that one side of the rectangle lies fully within the round, oval, elliptical or circular surface, wherein preferably all the corners of the omega-shaped profile are rounded. An omega-shaped profile may thereby look mushroom-shaped. Preferably, an oval or circular surface is connected to a rectangle to form the omega shape.

Use of a non-rotationally symmetrical profile may prevent the at least one dental molding from being placed into the at least one receptacle with an undesired and incorrect orientation. This makes it simpler to carry out the method.

An omega shape is not rotationally symmetrical and can be produced particularly simply. In addition, an omega shape may be particularly stable, because the pin located under it has no weak points or predetermined breaking points.

In its various possible variant embodiments, the omega-shaped profile brings about protection against rotation, as well as protection against displacement of the dental molding relative to the receptacle.

It may be provided that the pin has the same profile shape as the top surface in cross-section parallel to the top surface, wherein the dimensions of the cross-section are preferably greater than the dimensions of the top surface.

This means the pin is of particularly stable embodiment.

It may be provided that the lateral opening is arranged in the circumferential surface of the at least one dental molding approximally or orally, preferably is arranged orally.

As a result, the adhesive exiting through the lateral opening in the circumferential surface of the at least one dental molding can be removed without the dental prosthesis being esthetically impaired in the labial region. The oral side can be particularly easily post-machined and there is no risk of two adjacent dental moldings being adhesively bonded together.

It may moreover be provided that the adhesive exiting from the lateral opening in the circumferential surface of the at least one dental molding is removed after step E) or before step F) and after step E).

This increases wearing comfort. A particular combined effect is obtained in that the adhesive exits completely or primarily through the lateral opening in the circumferential surface of the at least one dental molding and accordingly has to be removed only, or only in large quantities, at this one location, thus substantially simplifying post-machining by removing of the adhesive.

It may also be provided that the lateral opening in the circumferential surface of the at least one dental molding has a cross-section of at least 0.1 mm, preferably has a cross-section of at least 0.3 mm, particularly preferably has a cross-section of at least 0.5 mm, and/or the lateral opening in the circumferential surface of the at least one dental molding has a cross-section of at most 10 mm, preferably a cross-section of at most 4 mm, particularly preferably a cross-section of at most 2 mm.

The cross-section of the lateral opening in the circumferential surface of the at least one dental molding is in particular the free passage cross-section which extends from the lateral circumferential surface of the at least one dental molding as far as into the basal cavity of the at least one dental molding.

The lower limits ensure that the adhesive can exit straightforwardly through the lateral opening in the circumferential surface and that fabrication of the lateral opening in the circumferential surface can be achieved inexpensively using conventional CAM methods.

The upper limits ensure that the external shape of the dental molding does not deviate too much from the ideal shape in the region of the gingival margin of the prosthetic base and any lingual irritation triggered thereby is minimal.

According to a preferred further development of the present invention, the lateral opening in the circumferential surface of the at least one dental molding has a cross-section of 0.1 mm to 10 mm, particularly preferably of 0.3 mm to 4 mm, very particularly preferably of 0.5 mm to 2 mm.

These dimensions are suitable for simple production of the lateral opening in the circumferential surface of the at least one dental molding and at the same time are suitable for discharge of the adhesive.

The objects underlying the present invention are also achieved by a device for implementing a method according to the invention, the device having a first calculation module for calculating a 3D CAD model of a prosthetic base with at least one receptacle for attachment of at least one dental molding, wherein protruding pins are arranged in each of the at least one receptacle,
a second calculation module for calculating at least one virtual 3D CAD model of the at least one dental molding with a basal cavity for receiving the pins, wherein the second calculation module carries out calculation of virtual 3D data of a lateral opening in the circumferential surface of the at least one virtual 3D CAD model of the at least one dental molding, such that when the dental molding has been fully inserted into the prosthetic base, the lateral opening in the circumferential surface of the at least one dental molding protrudes at least in places in the coronal direction beyond an adjacent gingival margin of the prosthetic base and the basal cavity is connected with the lateral opening in the circumferential surface of the at least one dental molding, and
a prosthetic base CAM device for producing the prosthetic base in line with the first calculation module and/or a dental molding CAM device for producing or machining the at least one dental molding in line with the second calculation module.

The prosthetic base CAM device for producing the prosthetic base may be a computer-controlled 5-axis milling machine or a 3D printer. The dental molding CAM device for producing or machining the at least one dental molding may be a computer-controlled 5-axis milling machine.

The first calculation module may also be configured such that, using the second calculation module, a gingival margin of the 3D CAD model of the prosthetic base can be constructed or displaced as a function of the position of the lateral opening in the circumferential surface of the at least one dental molding in the prosthetic base in such a way that the lateral opening in the circumferential surface of the at least one dental molding protrudes in the coronal direction beyond the gingival margin, preferably by at least 0.1 mm, particularly preferably at least 0.3 mm. This ensures that the lateral opening in the circumferential surface of the at least one dental molding is free and open, such that excess adhesive can exit through the lateral opening.

It may be provided that the first calculation module may be used to calculate a top surface at the coronal end of the pin and the second calculation module may be used to calculate a coronal base surface in the basal cavity of the at least one dental molding which matches the top surface.

In this way, using the first calculation module and the second calculation module, the occlusion, i.e., the occlusal height of the at least one dental molding in the prosthetic base, can be adjusted precisely such that the bearing surface at the coronal end of the pin lies flush with the coronal base surface in the basal cavity in the virtual model and this corresponds to the desired final position of the at least one dental molding in the prosthetic base and thereby precisely determines the occlusion.

The objects underlying the present invention are further achieved by a dental molding for producing a dental prosthesis, in which the dental molding has a basal cavity and a lateral opening in the circumferential surface of the dental molding, wherein the lateral opening is connected to the basal cavity, wherein a coronal base surface is arranged in the basal cavity for positioning the dental molding on a pin, wherein the coronal base surface has indexing or a non-rotationally symmetrical profile.

It may be provided that the lateral opening in the circumferential surface of the at least one dental molding has a cross-section of at least 0.1 mm, preferably a cross-section of at least 0.3 mm, particularly preferably a cross-section of at least 0.5 mm.

The cross-section of the lateral opening in the circumferential surface of the dental molding is in particular the free passage cross-section which extends from the lateral circumferential surface of the dental molding as far as into the basal cavity of the dental molding.

The lower limits ensure that the adhesive can exit straightforwardly through the lateral opening in the circumferential surface and that fabrication of the lateral opening in the circumferential surface can be achieved inexpensively using conventional CAM methods.

It may also be provided that the lateral opening in the circumferential surface of the at least one dental molding has a cross-section of at most 10 mm, preferably a cross-section of at most 4 mm, particularly preferably a cross-section of at most 2 mm.

The upper limits ensure that the external shape of the dental molding does not deviate too much from the ideal shape in the region of the gingival margin of the prosthetic base and any lingual irritation triggered thereby is minimal.

According to a preferred further development of the present invention, the lateral opening in the circumferential surface of the at least one dental molding has a cross-section of 0.1 mm to 10 mm, particularly preferably of 0.3 mm to 4 mm, very particularly preferably of 0.5 mm to 2 mm.

These dimensions are suitable for simple production of the lateral opening in the circumferential surface of the dental molding and at the same time are suitable for discharge of the adhesive.

It is provided that a coronal base surface is arranged in the basal cavity for positioning the dental molding on a pin, wherein the coronal base surface has indexing or a non-rotationally symmetrical profile, particularly preferably an omega shape.

In this way, the dental molding may be placed and attached particularly simply on a matching prosthetic base with matching pin.

It may further be provided that the lateral opening in the circumferential surface of the dental molding extends so far in the coronal direction that, when fully inserted in the prosthetic base, it protrudes at least in places in the coronal direction beyond an adjoining gingival margin of the prosthetic base.

This ensures that the adhesive for connecting the dental molding to the prosthetic base above the gingival margin can be discharged through the lateral opening in the circumferential surface of the dental molding and be simply removed there.

The objects underlying the present invention are also achieved by a dental prosthesis produced using a method according to the invention.

The invention is based on the surprising recognition that the basal cavity in the dental molding, in interaction with the pin in the receiving surface of the prosthetic base, makes it possible to achieve simple centering and orientation of the dental molding in the receiving surface of the prosthetic base, the occlusal height (occlusion) of the tooth in the prosthetic base also being precisely adjustable by the pin and the basal cavity when modifications are made to the lower basal edge of the dental molding, and at the same time to provide a free and localized overflow for excess adhesive in the form of the lateral opening in the circumferential surface of the dental molding, such that the adhesive can exit unimpeded through the lateral opening in the circumferential surface of the at least one dental molding and can be removed from there without difficulty, without this having any negative impact on the adhesive gap between the dental molding and the prosthetic base. In this way, excess adhesive can run out via the lateral opening in the circumferential surface of the at least one dental molding. If the pin and the basal cavity in each case have a suitable profile, in particular if a top surface of the pin and a coronal base surface of the basal cavity have matching profiles, protection against rotation is provided in this way and at the same time the dental molding and the prosthetic base are connected together in this region in abutting manner, such that the desired occlusal height or the desired occlusion can be very precisely adjusted. The extremely low structural height resulting from the measures according to the invention allows the use of existing dental moldings with a basal cavity, newly developed dental molding lines, as well as shortened dental moldings with integral geometry.

A further advantage of the present invention can be considered to be the fact that the adhesive for connecting the dental molding to the prosthetic base is discharged purposefully at a point between the prosthetic base and the dental moldings, whereby the excess adhesive may be purposefully removed at this point, the risk thereby also being reduced of the exiting excess adhesive blocking the interdental spaces, of a plurality of dental moldings being connected together and the interdental spaces between individual dental moldings thereby being closed. Adhesive can be removed from the region of the interdental spaces only with great difficulty.

Structural incorporation of a suitable profile into the top surface of the pin and into the coronal base surface of the basal cavity (for example in the form of an omega profile), with an oral viewing window in the form of the lateral opening in the circumferential surface of the artificial dental molding, fulfills, together with the matching prosthetic base, the requirements formulated above as the objects of the invention. The lateral surfaces of the profile may be embodied both conically and in parallel. The oral viewing window (the lateral opening in the circumferential surface of the at least one dental molding) further provides the possibility of monitoring by visual inspection to achieve the final position. The lateral opening in the circumferential surface of the at least one dental molding thereby increases process reliability and allows checking for a good fit. The user may thus carry out a visual inspection of the desired seat of the dental molding in the prosthetic base, whereby possible malpositioning may be prevented. All the structural dimensions are preferably selected such that they may be implemented for dental milling using standard tools and a 3D printer.

Precise fitting of at least one dental molding proceeds by way of surfaces embodied in part without an adhesive gap (for example horizontal surfaces for vertical fitting, such as for example the top surface of the pin and the coronal base surface of the basal cavity). Any adhesive applied to these surfaces without an adhesive gap is completely pressed out again and so ensures an exact fit.

The orally located monitoring window optionally already has a slight indentation in the surface, which after the adhesive bonding process enables complete esthetic coverage with tooth-colored material.

Exemplary embodiments of the invention are explained below with reference to six schematic figures and one flow chart but without thereby limiting the invention. In the figures:

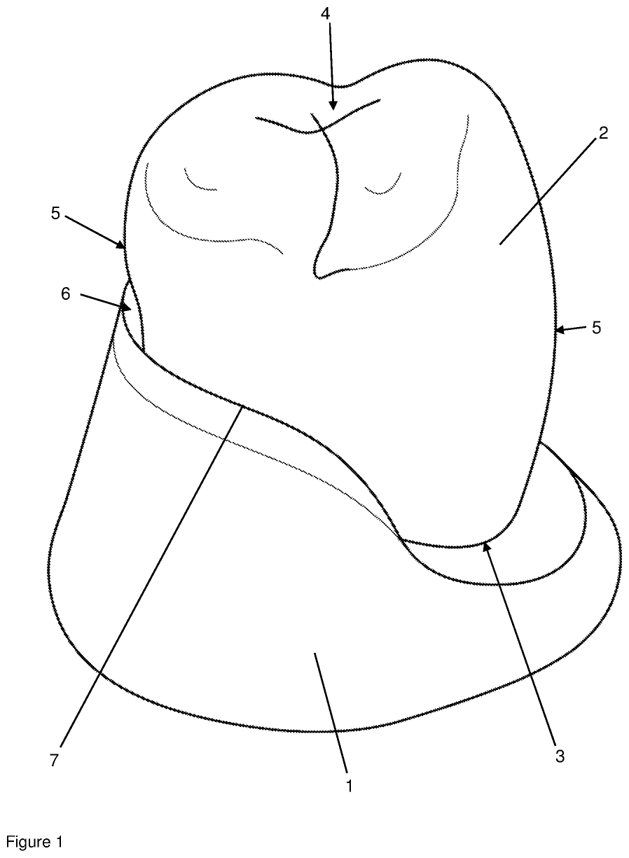

FIG. 1 is a schematic perspective view of a dental molding inserted into a prosthetic base for producing a dental prosthesis;

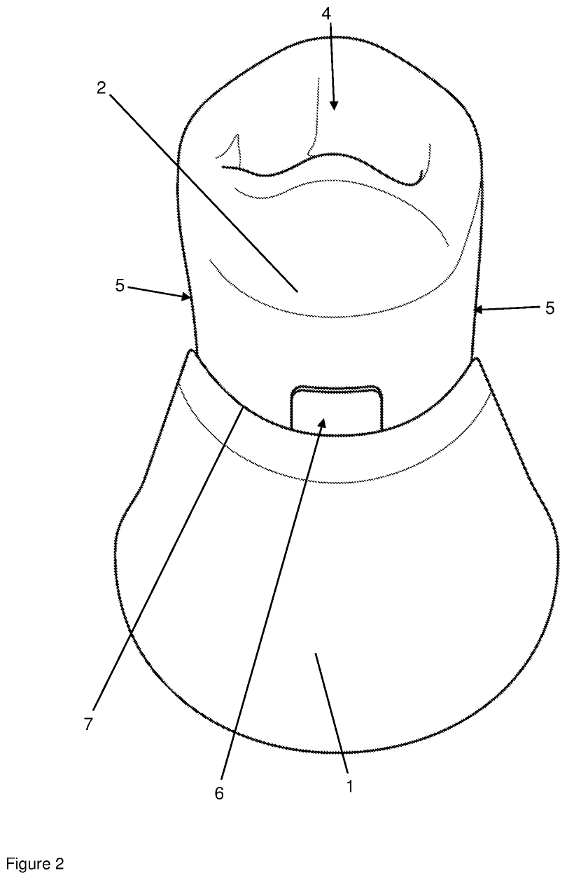

FIG. 2 is a schematic perspective view of the dental molding inserted into the prosthetic base according to FIG. 1 from another perspective;

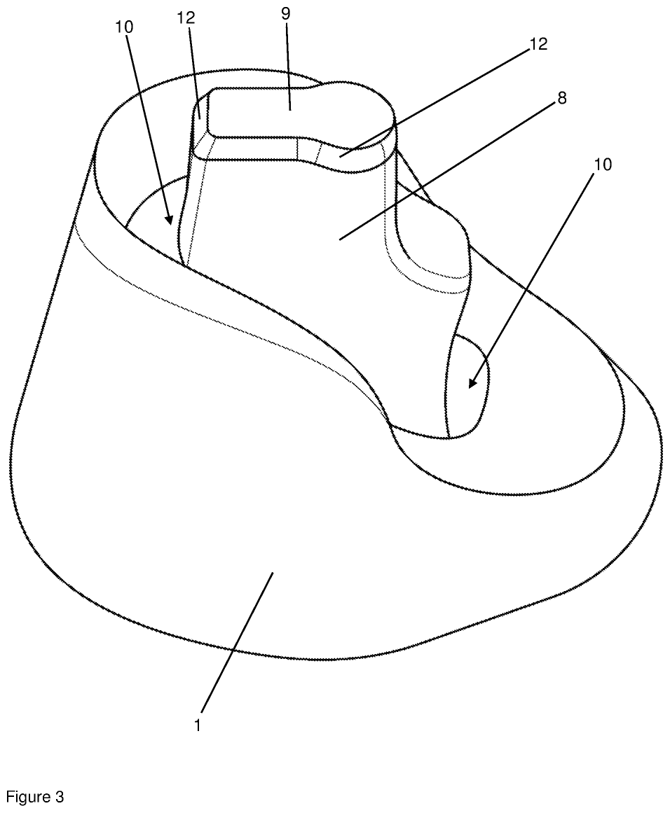

FIG. 3 is a schematic perspective view of the prosthetic base according to FIGS. 1 and 2;

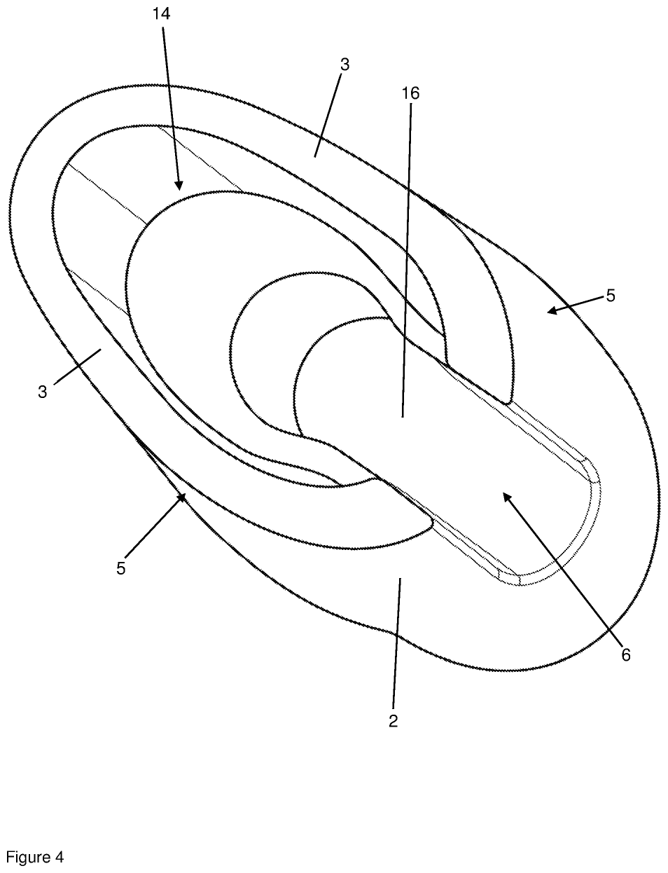

FIG. 4 is a schematic perspective basal view of the dental molding according to FIGS. 1 and 2;

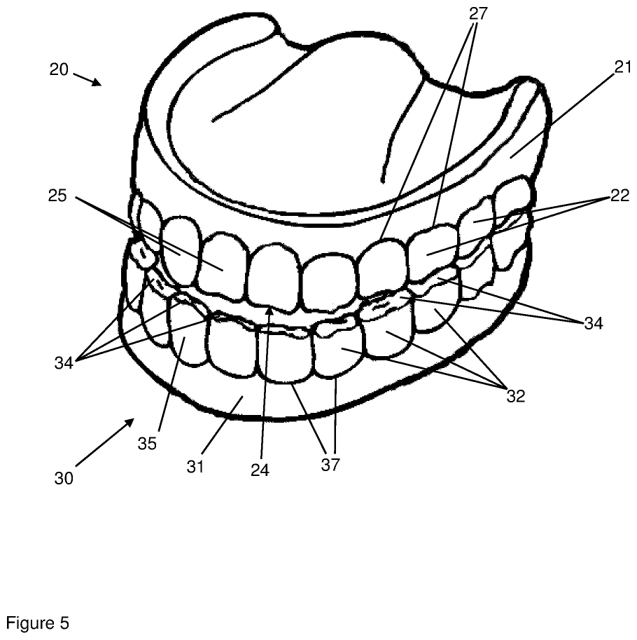

FIG. 5 is a schematic perspective view of a dental prosthesis for the upper jaw and a dental prosthesis for the lower jaw;

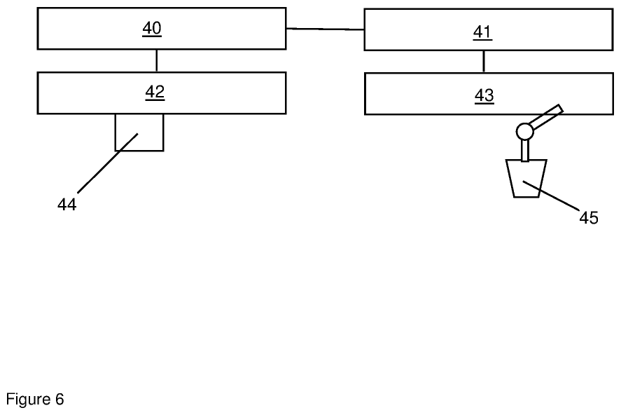

FIG. 6 is a schematic diagram of a device according to the invention for implementing a method according to the invention; and

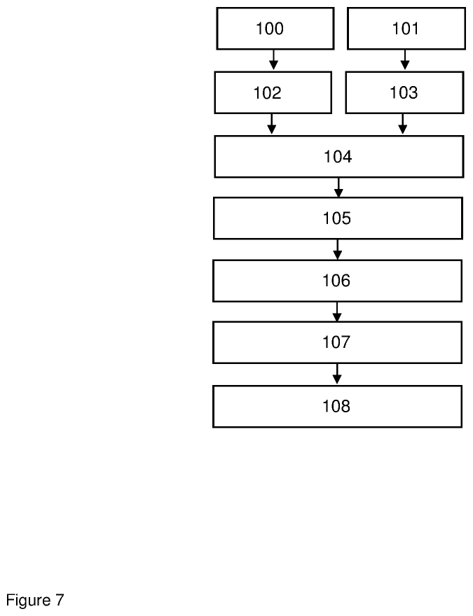

FIG. 7 shows the sequence of a method according to the invention for producing a dental prosthesis.

FIGS. 1 and 2 show two schematic perspective views of a prosthetic base 1 into which a dental molding 2 has been inserted, wherein the two views are from different directions. FIG. 3 shows the prosthetic base 1 and FIG. 4 the dental molding 2, in each case separately. The prosthetic base 1 may be used to lie on or be attached to the gingiva. The prosthetic base 1 may take the form of imitation gum. The prosthetic base 1 may consist of a pink-colored or gum-colored plastics material. Color and transparency may be selected to match the appearance of gums. The dental molding 2 preferably consists of a tooth-colored plastics material or of a tooth-colored ceramic material. Ceramic or inorganic fillers may be present in the plastics material. On one side of the prosthetic base 1, a receptacle 10 (not shown in FIGS. 1 and 2, but visible in FIG. 3) may be provided for fixing the dental molding 2 in place. The receptacle 10 may take the form of an indentation in the occlusal surface of the prosthetic base 1 in the direction of a jaw ridge as a support for the prosthetic base 1.

The dental molding 2 may have a basal side 3, a coronal surface 4 opposite the basal side 3 and a circumferential surface 5. The circumferential surface 5 is the laterally circumferential surface of the dental molding 2, which connects the basal side 3 to the coronal surface 4. The term “circumferential surface” is here derived from the cylindrical geometry of the dental molding 2, wherein the cylinder axis of the dental molding 2 runs from the center of the basal side 3 to the middle of the coronal surface 4 through the centroid of the dental molding 2. The basal side 3 may also be denoted cervical side and serves as connection to the prosthetic base 1. The coronal surface 4 may also be denoted chewing surface.

The dental molding 2 has a lateral opening 6 in the circumferential surface 5 of the dental molding 2. The lateral opening 6 in the circumferential surface 5 of the dental molding 2 may be arranged in the circumferential surface 5 of the dental molding 2 such that the lateral opening 6 projects in the coronal direction beyond a gingival margin 7 of the prosthetic base 1 when the dental molding 2 has been pushed fully into the receptacle 10 of the prosthetic base 1. When correctly positioned in the prosthetic base 1, the lateral opening 6 may be arranged on the oral side.

The receptacle 10 may form an indentation on a top of the prosthetic base 1, such that an external basal edge of the dental molding 2 has to be inserted into the indentation in order to connect the dental molding 2 to the receptacle 10. A pin 8 may extend from the receptacle 10 of the prosthetic base 1 (see FIG. 3), onto which pin 8 the dental molding 2 may be placed. The pin 8 may end in a top surface 9. The top surface 9 may have an omega shape. A conical transitional surface 12 surrounding the top surface 9 may be arranged in the region of the top surface 9, in order to enable guidance of the pin 8 in a basal cavity 14 of the dental molding 2 (see FIG. 4) and thus simplify insertion of the dental molding 2 into the prosthetic base 1.

The lateral opening 6 in the circumferential surface 5 of the dental molding 2 extends as far as into a basal cavity 14 of the dental molding 2. The basal cavity 14 is thereby accessible from the lateral opening 6. The basal cavity 14 may have a coronal base surface 16. The coronal base surface 16 may fit flush with the top surface 9 of the pin 8. The coronal base surface 16 may to this end have an omega shape. If the coronal base area 16 and the top surface 9 rest against one another, the desired position of the dental molding 2 in the prosthetic base 1 may be achieved. The desired position of the dental molding 2 in the prosthetic base 1 is then defined by this contact surface.

FIGS. 1 to 4 show an exemplary embodiment of the prosthetic base 1 in which just a single dental molding 2 is used. This exemplary embodiment may however be straightforwardly applied to prosthetic bases with multiple receptacles for a dental molding or for multiple dental moldings. Such variants are known from the prior art. For a person skilled in the art, the present exemplary embodiment is thus straightforwardly applicable to other variants with multiple receptacles and multiple dental moldings. In the case of a prosthetic base with multiple receptacles, the receptacles and preferably the pins may have indexing in the receptacles, such that the dental moldings with matching basal side or surface can only be inserted in the prosthetic base in a specific orientation, and each dental molding fits with just one receptacle.

FIGS. 1 to 4 may also show a virtual model of a dental molding 2 and a prosthetic base 1. The virtual model of the dental molding 2 and of the prosthetic base 1 may be obtained from a virtual model of a dental prosthesis, the virtual model of the dental prosthesis being computationally divided by file splitting into the virtual model of the prosthetic base 1 and the virtual model of the dental molding 2. Multiple dental moldings (not shown) may be present in singulated manner as individual prosthetic teeth, as shown for the individual dental moldings 2 in FIG. 4, or they may also be constructed as a cohesive group of prosthetic teeth (not shown).

FIG. 5 shows a schematic representation of a dental prosthesis 20 for an upper jaw and a dental prosthesis 30 for a lower jaw in occlusion. The dental prosthesis 20 for the upper jaw and the dental prosthesis 30 for the lower jaw are both full prostheses. The dental prosthesis 20 for the upper jaw has a prosthetic base 21 and a full set of dental moldings 22. The dental moldings 22 are adhesively bonded in receptacles of the prosthetic base 21.

The dental moldings 22 of the dental prosthesis 20 for the upper jaw may in each case have a basal side, a coronal surface 24 opposite the basal side and a circumferential surface 25. The circumferential surface 25 is the laterally circumferential surface of the dental moldings 22, which connects the basal side and the coronal surface 24. As with the first embodiment in FIGS. 1 and 2, the basal side is adhesively bonded into a receptacle of the prosthetic base 21 and is therefore not visible in FIG. 5. The term “circumferential surface” is here derived from the cylindrical geometry of the dental molding 22, wherein the cylinder axis of the dental molding 22 runs from the center of the basal side to the middle of the coronal surface 24 through the centroid of the dental molding 22. The basal side may also be denoted the cervical side and serves to connect the dental molding 22 to the prosthetic base 21. The coronal surface 24 may also be denoted chewing surface.

The dental moldings 32 of the dental prosthesis 30 for the lower jaw may in each case have a basal side, a coronal surface 34 opposite the basal side and a circumferential surface 35. The circumferential surface 35 is the laterally circumferential surface of the dental moldings 32, which connects the basal side and the coronal surface 34. As with the first embodiment in FIGS. 1 and 2, the basal side is adhesively bonded into a receptacle of the prosthetic base 31 and is therefore not visible in FIG. 5. The term “circumferential surface” is here derived from the cylindrical geometry of the dental molding 32, wherein the cylinder axis of the dental molding 32 runs from the center of the basal side to the middle of the coronal surface 34 through the centroid of the dental molding 32. The basal side may also be denoted the cervical side and serves to connect the dental molding 32 to the prosthetic base 31. The coronal surface 34 may also be denoted chewing surface.

The dental moldings 22, 32 may have a structure similar to the dental molding 2 according to FIGS. 1, 2 and 4. Each of the dental moldings 22, 32 thus has a lateral opening (not visible in FIG. 5) in the circumferential surface 25, 35 on the oral side of the dental molding 22, 32. The lateral opening in the circumferential surface 25, 35 of the dental molding 22, 32 may be arranged in the circumferential surface 25, 35 of the dental molding 22, 32 in such a way that the lateral opening projects in the coronal direction beyond a gingival margin 27, 37 of the prosthetic base 21, 31, into which the respective dental molding 22, 32 has been inserted, when the dental molding 22, 32 has been pushed fully into the associated receptacle of the prosthetic base 21, 31.

As in the first exemplary embodiment, the receptacles of the prosthetic bases 21, 31 may form an indentation on a top of the prosthetic base 21, 31, such that an external basal edge of the dental moldings 22, 32 has to be inserted into the matching indentation in order to connect the dental molding 22, 32 to the receptacle. A pin may extend out of each of the receptacles of the prosthetic base 21, 31 (not visible in FIG. 5 but similar to FIG. 3), onto which pin the in each case matching dental molding 22, 32 may be placed. The pin may end in a top surface. The top surface may have an omega shape.

The lateral openings in the circumferential surface 25, 35 of the dental moldings 22, 32 extend as far as into a basal cavity (not visible in FIG. 5). The basal cavity is thereby accessible from the lateral opening. The basal cavity may have a coronal base surface. The coronal base surface may match the top surface of the pin. The coronal base surface may for this purpose have an omega shape. If the coronal base surface and the top surface rest against one another, the desired position of the dental molding 22, 32 in the prosthetic base 21, 31 may be achieved. The desired position of the dental molding 22, 32 in the prosthetic base 21, 31 is then defined by this contact surface.

FIG. 6 shows a schematic representation of an exemplary device according to the invention for implementing a method according to the invention for producing a dental prosthesis.

The device may have a first calculation module 40, with which a 3D CAD model of a prosthetic base is calculated as a virtual model. The device may furthermore have a second calculation module 41, with which a 3D CAD model of a dental molding is calculated as a virtual model. The first calculation module 40 and the second calculation module 41 are here connected together to exchange data, so as to be able to synchronize the 3D CAD model of the at least one dental molding with the 3D CAD model of the prosthetic base and adapt the two to one another. The second calculation module 41 may be programmed in such a way or configured in such a way that virtual 3D data for a lateral opening in the circumferential surface of the virtual 3D CAD model of the at least one dental molding are calculated such that when the dental molding has been fully inserted into the prosthetic base, the lateral opening in the circumferential surface of the at least one dental molding protrudes at least in places in the coronal direction beyond an adjoining gingival margin of the prosthetic base and a basal cavity is connected with the lateral opening in the circumferential surface of the at least one dental molding, wherein the data relating to the prosthetic base are provided to this end by the first calculation module 40 via the data link. The second calculation module 41 may also be programmed or configured to calculate the arrangement of the basal cavity in dental moldings, or to insert the basal cavity into the virtual model of the dental molding.

The first calculation module 40 may be connected with a prosthetic base CAM device 42 to produce a prosthetic base based on the virtual model of the prosthetic base calculated with the first calculation module 40. Likewise, the second calculation module 41 may be connected with a dental molding CAM device 43 to produce or basally machine dental moldings. The prosthetic base CAM device 42 for producing the prosthetic base may be a computer-controlled 5-axis milling machine or a 3D printer. The prosthetic base CAM device 42 may to this end have a print head 44 for printing the prosthetic base from a gum-colored plastics material. The dental molding CAM device 43 for producing or machining the at least one dental molding may be a computer-controlled 5-axis milling machine and have a milling head 45 on an appropriately movable swivel arm.

The first calculation module 40 may be used to calculate a bearing surface at the coronal end of a pin in a receptacle of the prosthetic base and the second calculation module 41 may be used to calculate a coronal base surface in the basal cavity of the at least one dental molding which matches the bearing surface.

An exemplary method is explained below with reference to the dental prosthesis described in FIGS. 1 to 4. The sequence of the exemplary method is shown in the diagram according to FIG. 7. The description is, however, also straightforwardly transferable to other exemplary embodiments.

In a first processing step 100, a prosthetic base 1 is calculated as a virtual CAD model. The virtual CAD model of the prosthetic base 1 may be calculated, for example, from CAD data of a dental prosthesis, and a CAD model of the dental moldings 2 and a CAD model of the prosthetic base 1 may be generated by way of file splitting. The prosthetic base 1 is here calculated with receptacle(s) 10 for the at least one dental molding 2, wherein a protruding pin 8 is calculated in the at least one receptacle 10.

In parallel, in a second processing step 101, virtual CAD models of at least one dental molding 2 are calculated, which match the prosthetic base 1 according to processing step 100. In the process, a basal cavity 14 and the lateral opening 6 in the circumferential surface 5 of the dental molding 2 may be included in the calculation of the virtual CAD model of the dental molding 2. The lateral opening 6 may be arranged in the circumferential surface 5 in such a way that the lateral opening 6 projects beyond the gingival margin 7 in the coronal direction when connected to the prosthetic base 1, such that the basal cavity 14 remains connected to the area surrounding the prosthetic base 1 by way of the lateral opening 6.

In a third processing step 102, the prosthetic base 1 is produced on the basis of the virtual CAD model of the prosthetic base 1 calculated in step 100 or a prosthetic base 1 with known external shape is provided, with at least one receptacle 10 for at least one dental molding 2 and with a pin 8 in the receptacle 10 for each receptacle 10.

In a fourth processing step 103, the at least one dental molding 2 is produced or at least one dental molding 2 is basally machined on the basis of the virtual CAD model of the at least one dental molding 2 calculated in step 101.

In a fifth processing step 104, an adhesive may be applied basally to the at least one dental molding 2 and/or to the receptacle(s) 10 of the prosthetic base 1. Prior to that, the receptacle(s) 10 and/or the basal side 3 of the at least one dental molding 2 may be cleaned and/or roughened and/or swollen, to improve the connection between the at least one dental molding 2 and the prosthetic base 1. The adhesive is here applied in excess, i.e., a larger amount of adhesive is applied than the space between the dental molding 2 and the respective receptacle 10 appears to require.

Then, in a sixth processing step 105, the at least one dental molding 2 can be inserted into the receptacle(s) 10 of the prosthetic base 1 such that the pin 8 is arranged within the basal cavity 14 in the at least one dental molding 2.

In a seventh processing step 106, the at least one dental molding 2 is then pushed into the receptacle 10, wherein excess adhesive exits through the lateral opening 6 in the circumferential surface 5 of the at least one dental molding 2.

This exiting adhesive can then be simply removed in an eighth processing step 107. The lateral opening 6 in the circumferential surface 5 may in this case be arranged on the oral side, such that the exiting bone cement can be readily removed at this point and the external esthetic appearance of the dental prosthesis is not impaired.

In a ninth processing step 108, the adhesive may be cured and, in this way, the at least one dental molding 2 may be definitively connected to the prosthetic base 1. The resultant dental prosthesis may then optionally also be polished and given a final clean.

The features of the invention disclosed in the preceding description, as well as in the claims, figures and exemplary embodiments, may be essential both individually and in any combination for realizing the invention in its various embodiments.

### LIST OF REFERENCE SIGNS

1 Prosthetic base
2 Dental molding
3 Basal side
4 Coronal surface
5 Circumferential surface
6 Lateral opening
7 Gingival margin
8 Pin
9 Top surface
10 Receptacle
12 Conical transitional surface
14 Basal cavity
16 Coronal base surface
20 Dental prosthesis for upper jaw
21 Prosthetic base
22 Dental molding
24 Coronal surface
25 Circumferential surface
27 Gingival margin
30 Dental prosthesis for upper jaw
31 Prosthetic base
32 Dental molding
34 Coronal surface
35 Circumferential surface
37 Gingival margin
100 Processing step: calculating a virtual model of a prosthetic base
101 Processing step: generating a virtual model of at least one dental molding
102 Processing step: producing or providing a prosthetic base
103 Processing step: producing or machining at least one dental molding
104 Processing step: applying adhesive
105 Processing step: inserting the at least one dental molding
106 Processing step: pushing in the at least one dental molding
107 Processing step: removing excess adhesive
108 Processing step: curing adhesive and optionally post-machining

1. A method for producing dental prostheses in the form of partial or full dental prostheses, wherein each dental prosthesis has a prosthetic base and at least one dental molding and wherein the method comprises the following steps:
A) producing a prosthetic base from a gum-colored plastic material, wherein the prosthetic base is created with at least one receptacle for at least one dental molding and wherein a protruding pin is created in the at least one receptacle, or
providing a prosthetic base of a gum-colored plastic material, wherein the prosthetic base has at least one receptacle for at least one dental molding and wherein a protruding pin is arranged in the at least one receptacle;
B) producing or basally machining at least one dental molding, wherein a basal cavity for receiving the pin is created in the at least one dental molding or the at least one dental molding has a basal cavity for receiving the pin, wherein a lateral opening is created in a circumferential surface of the at least one dental molding, such that the basal cavity is accessible via the lateral opening in the circumferential surface of the at least one dental molding;
C) subsequently applying an adhesive into the basal cavity of the at least one dental molding or into the at least one receptacle of the prosthetic base or into the basal cavity of the at least one dental molding and into the at least one receptacle of the prosthetic base;
D) subsequently inserting the at least one dental molding into the at least one receptacle of the prosthetic base, such that the protruding pin is arranged inside the basal cavity;
E) subsequently pushing the at least one dental molding into the at least one receptacle, and excess adhesive exiting through the lateral opening in the circumferential surface of the at least one dental molding, wherein the lateral opening in the circumferential surface of the at least one dental molding protrudes at least in places in a coronal direction beyond an adjoining gingival margin of the prosthetic base; and
F) subsequently curing the adhesive to definitively connect the at least one dental molding to the prosthetic base.

2. The method according to claim 1, wherein, in step B), when producing or basally machining the at least one dental molding, and in step A), when producing the prosthetic base, a virtual 3D model of a dental prosthesis is created or provided with a virtual model of the prosthetic as imitation gum and with at least one virtual model of the at least one dental molding to be arranged in the prosthetic base to reproduce at least one tooth.

3. The method according to claim 2, wherein the lateral opening in the circumferential surface of the at least one dental molding is added computationally in the virtual model or in the virtual models within the scope of the method, wherein optionally the lateral opening is added in such a way in the circumferential surface of the at least one dental molding that the lateral opening in the circumferential surface of the at least one dental molding projects in the coronal direction beyond the gingival margin of the prosthetic base when the at least one dental molding is inserted fully into the receptacle assigned thereto, wherein particularly preferably the lateral opening in the circumferential surface of the at least one dental molding projects in the coronal direction by at least 0.1 mm beyond the gingival margin of the prosthetic base, optionally the lateral opening in the circumferential surface of the at least one dental molding projects in the coronal direction by at least 0.3 mm beyond the gingival margin of the prosthetic base.

4. The method according to claim 1, wherein in step E) the at least one dental molding is pushed into the at least one receptacle up to a limit stop, optionally wherein the limit stop is formed by a coronal end of the pin and by a mating stop at the coronal base in the basal cavity.

5. The method according to claim 1, wherein on pushing the at least one dental molding into the at least one receptacle, in step E) the pin is guided in the basal cavity and the at least one dental molding is thereby oriented and positioned relative to the prosthetic base.

6. The method according to claim 1, wherein the pin of the at least one receptacle and the basal cavity of the at least one dental molding is produced with rounded structures with a radius of curvature of at least 0.3 mm or has rounded structures with a radius of curvature of at least 0.3 mm, optionally is produced with a radius of curvature of at least 0.5 mm or has a radius of curvature of at least 0.5 mm.

7. The method according to claim 1, wherein a top surface of the pin of the at least one receptacle and a coronal base surface in the basal cavity of the at least one dental molding have a non-rotationally symmetrical profile or are produced with a non-rotationally symmetrical profile, or
a top surface of the pin of the at least one receptacle and a coronal base surface in the basal cavity of the at least one dental molding have an omega-shaped profile or are produced with an omega-shaped profile.

8. The method according to claim 1, wherein the lateral opening is arranged in the circumferential surface of the at least one dental molding approximally or orally.

9. The method according to claim 1, wherein the adhesive exiting from the lateral opening in the circumferential surface of the at least one dental molding is removed after step E) or before step F) and after step E).

10. The method according to claim 1, wherein the lateral opening in the circumferential surface of the at least one dental molding has a cross-section of at least 0.1 mm, optionally a cross-section of at least 0.3 mm or at least 0.5 mm and/or the lateral opening in the circumferential surface of the at least one dental molding has a cross-section of at most 10 mm, optionally a cross-section of at most 4 mm or at most 2 mm.

11. A device for implementing a method according to claim 1, the device having
a first calculation module for calculating a 3D CAD model of a prosthetic base with at least one receptacle for attachment of at least one dental molding, wherein protruding pins are arranged in each of the at least one receptacle,
a second calculation module for calculating at least one virtual 3D CAD model of the at least one dental molding with a basal cavity for receiving the pins, wherein the second calculation module carries out calculation of virtual 3D data of a lateral opening in the circumferential surface of the at least one virtual 3D CAD model of the at least one dental molding, such that when the dental has been fully inserted into the prosthetic base, the lateral opening in the circumferential surface of the at least one dental molding protrudes at least in places in the coronal direction beyond an adjacent gingival margin of the prosthetic base and the basal cavity is connected with the lateral opening in the circumferential surface of the at least one dental molding, and
a prosthetic base CAM device for producing the prosthetic base in line with the first calculation module and/or a dental molding CAM device for producing or machining the at least one dental molding in line with the second calculation module.

12. The device according to claim 11, wherein the first calculation module may be used to calculate a top surface at the coronal end of the pin and the second calculation module may be used to calculate a coronal base surface in the basal cavity of the at least one dental molding which matches the top surface.

13. A dental molding for producing a dental prosthesis, wherein the dental molding has a basal cavity and a lateral opening in a circumferential surface of the dental molding, wherein the lateral opening is connected to the basal cavity, wherein
a coronal base surface is arranged in the basal cavity for positioning the dental molding on a pin, wherein the coronal base surface has indexing or a non-rotationally symmetrical profile.

14. The dental molding according to claim 13, characterized in that the coronal base surface has an omega shape.

15. The dental molding according to claim 13, wherein the lateral opening in the circumferential surface of the dental molding extends so far in a coronal direction that, when fully inserted in the prosthetic base, it protrudes at least in places in the coronal direction beyond an adjoining gingival margin of the prosthetic base.

16. A dental prosthesis produced using a method according to claim 1.

17. The dental molding according to claim 14, wherein the lateral opening in the circumferential surface of the dental molding extends so far in a coronal direction that, when fully inserted in the prosthetic base, it protrudes at least in places in the coronal direction beyond an adjoining gingival margin of the prosthetic base.
